(19) United States
(12) Patent Application Publication
(10) Pub. No.: US 2024/0390845 A1
(43) Pub. Date: Nov. 28, 2024

(54) POLYMERIC AMINE SORBENTS FOR GAS SEPARATION USING A MOISTURE SWING REGENERATION STEP

(71) Applicant: Svante Inc., Burnaby (CA)

(72) Inventors: Omid GHAFFARI-NIK, Burnaby (CA); Yan GAO, New Westminster (CA); Joel CIZERON, Burnaby (CA)

(21) Appl. No.: 18/255,812

(22) PCT Filed: Feb. 8, 2023
(86) PCT No.: PCT/IB2023/051130

§ 371 Date: Jun. 2, 2023

Related U.S. Application Data
(60) Provisional application No. 63/307,881, filed on Feb. 8, 2022.

(51) Int. Cl. B01D 53/62; B01D 53/04; B01J 20/28; B01J 20/32; B01J 20/34

(52) U.S. Cl. CPC B01D 53/62; B01D 53/04; B01J 20/28004; B01J 20/28011; B01J 20/28016; B01J 20/2804; B01J 20/28059; B01J 20/28071; B01J 20/28078; B01J 20/3276; B01J 20/3297; B01J 20/3425; B01J 20/3466; B01D 2253/202; B01D 2253/25; B01D 2253/306; B01D 2253/308; B01D 2257/504; B01D 2259/4009

(57) ABSTRACT

Polymeric amine solid sorbents with enhanced stability to moisture and/or oxygen for sorptive gas separation processes are disclosed. The polymeric amine solid sorbents can be supported on a porous support or integrated into solid porous polymer networks. Sorptive gas separators can employ contactors with such polymeric amine solid sorbents for separation of a component from a multi-component gas stream.

### FIELD

Embodiments of the present invention relate generally to solid amine sorbents, sorptive contactors, and methods for sorptive gas separation of a multi-component fluid stream using the same. More particularly, embodiments of the present invention relate to polymeric amine sorbents supported on an inorganic porous support or integrated into solid porous polymer networks with enhanced stability to moisture and/or oxygen and rapid carbon dioxide sorption capacity, sorptive contactors having polymeric amine sorbents, and methods for sorptive gas separation of an acid gas from a multi-component fluid stream using the same.

### BACKGROUND

Adsorptive separation processes are common in industrial separation processes and are considered for use in applications for mitigating the negative effects of greenhouse gas emissions and associated climate change. For example, adsorptive gas separation processes can be used to separate carbon dioxide from multi-component fluid streams such as an air, a flue gas, or a process gas. The cost of adsorptive separation processes is largely impacted by the amount of sorbent required to produce a certain throughput of purified product. This throughput per mass of sorbent is a simple product of adsorption cycle capacity and adsorption cycle time. In adsorptive gas separation processes using thermal swing or chemical swing desorption mechanisms, desorption of an adsorbed molecule or component can be a relatively slow process due to the need to introduce desorption energy into the system and effective transfer of that energy to the sorbent.

During a regeneration step of an adsorptive gas separation process, in some cases steam can be admitted into an adsorptive separator to contact and directly heat an adsorbent material, and/or purge the separated component from the adsorptive separator. Water in the product stream can then be separated from the product stream by condensation, thus increasing the purity of the remaining stream.

Moisture swing induced desorption of a target component can provide a fast and efficient means of desorbing adsorbed components, while resulting in a product stream which can be further purified by means of the condensation of gaseous water from the product stream. Benefits of moisture swing or relative humidity swing for desorption include: 1) rapid introduction of energy by using the heat of adsorption or condensation of the moisture to distribute heat energy relatively homogeneously throughout a porous sorbent; 2) water can be discharged to the atmosphere if desired and if not significantly contaminated and permitted; and 3) adsorbents with significant water adsorption capacity are fairly common.

Drawbacks of exposing conventional adsorbent materials to water and/or steam during an adsorptive separation process include: 1) water adsorbed strongly onto an adsorbent material can result in energy intensive and slow drying of the adsorbent material, which can result in a slow or long process cycle time; 2) the adsorbent material may degrade in the presence of water (for example, polymeric amine adsorbents can migrate due to partial solvation, making the amine mobile which results in loss of amine from the adsorbent material, and with metal-organic framework (MOF) adsorbents, their structure can undergo phase transition in the presence of steam resulting in pore collapse and/or loss of selective adsorption capacity), and/or 3) a water stability attribute of an adsorbent material is often inversely related to one or more desirable attributes (for example, target component adsorption capacity and/or reaction kinetics).

Furthermore, conventional adsorptive gas separators and processes typically use an adsorbent with a single adsorbent material where a regeneration step can include admitting steam into the adsorptive bed via an inlet, flowing the steam in contact with the adsorbent material in the adsorbent bed, desorbing a target component to form a product stream, and recovering the product stream from the adsorbent bed via an outlet or port.

Polymeric amines are desirable for some adsorptive gas separation applications due to their high affinity, selectivity, large adsorptive capacity and reaction kinetics for capturing a target component, for example, carbon dioxide (herein referred to as “CO₂”), relative to other adsorbents. However, polymeric amines with high primary and secondary amine content are typically water-soluble polymers, which offers challenges when using them as solid sorbents in processes which expose them to high relative humidity, condensation, and/or water, as moisture tends to leach away the amine. This shortcoming limits conventional solid sorbents containing such polymeric amines to applications where the adsorbents are exposed to dry or low relative humidity conditions, such as, gas chromatography applications. Furthermore, polymeric amines with high primary and secondary amine content tend to have limited stability when exposed to oxygen at elevated temperatures.

For commercial adoption of adsorptive gas separation, reduced life cycle costs and increased sorbent durability are required. An intensified adsorptive gas separation process and sorbents having desirable selectivity, high adsorption capacity, fast reaction kinetics and high durability are therefore desirable.

### SUMMARY

In embodiments, a solid sorbent is disclosed comprising a polymeric amine with average molecular weight greater than 2000 Dalton, wherein the solid sorbent is insoluble in water and forms a porous network, and is in the form of particles or a film or a sheet.

In a broad aspect, a sorptive gas separation process for separating a first component from a multi-component fluid stream having at least a first component of a first concentration and a second component, comprises: 1) providing a sorptive gas contactor with a solid sorbent comprising a polymeric amine with average molecular weight greater than 2000 Dalton, wherein the solid sorbent is insoluble in water and forms a porous network, and is in the form of particles or a film or a sheet, 2) flowing the multi-component fluid stream through the sorptive gas contactor, 3) sorbing at least a portion of the first component from the multi-component fluid stream onto the solid sorbent, 4) forming a first product stream, and 5) recovering the first product stream from the sorptive gas contactor, wherein a concentration of the first component in the first product stream is less than the first concentration of the first component in the multi-component fluid stream, 5) desorbing at least a portion of the first component sorbed on the solid sorbent for forming a second product stream, 6) recovering the second product stream from the sorptive gas contactor, wherein the second product stream is enriched in the first component relative to the multi-component fluid stream, such that a concentration of the desorbed first component in the second product stream is greater than the first concentration of the first component in the multi-component fluid stream.

In embodiments, the disclosed solid sorbent can comprise at least a polymeric amine formed into a porous solid having a CO₂ equilibrium capacity. In embodiments, the solid sorbent can have a CO₂ equilibrium capacity to heat capacity ratio of between 15 to 40 cc stp CO₂/(J/K) (stp=Standard Temperature and Pressure) per unit heat capacity of the solid sorbent, where the equilibrium capacity is measured at 50° C. under a 15% CO₂ feed mixture. In embodiments, the solid sorbent can have a kinetic adsorption rate, wherein the kinetic adsorption rate is greater than 0.03 mmol/g/s when in contact with a CO₂ mixture, where the CO₂ mixture comprises 15% CO₂ and a temperature between 30° C. and 50° C., and can have a heat of adsorption for CO₂, wherein the heat of adsorption for CO₂ is between 70 and 120 kj/mol of CO₂ adsorbed.

In embodiments, the disclosed sorptive gas contactor can comprise a plurality of sorbent sheets, each sheet comprising a solid sorbent. In embodiments, the each sorbent sheet can have a thickness in a range of 0.1 mm to 3 mm, or preferably in a range of 0.2 mm to 1 mm. The plurality of sheets can be positioned to form passages therebetween, enabling or otherwise permitting a flow of a gas stream between the plurality of sheets and through the passages, and coming into contact with the sorbent sheets. In embodiments, each of the plurality of solid sorbent sheets can have a density in a range of 0.2 g/cm³ to 0.8 g/cm³, and comprise a polymeric amine polymer with greater than 5 weight % of nitrogen from a primary or a secondary amine functional group, wherein the polymeric amine can be formed as a co-polymer from a vinyl amine monomer with a molecular weight less than 100 Dalton and a divinyl monomer with a molecular weight greater than 100 Dalton, or formed from a reaction of a water-soluble polymeric amine with long chain alkyl (8 carbon or greater) groups.

### BRIEF DESCRIPTION OF THE DRAWINGS

FIG. 1a is a perspective view illustrating a pair of sorbent sheets, each sheet with a planar shape, and defining a passage therebetween, forming the pair of sorbent sheets;

FIG. 1b is a cross-sectional view of a sorbent sheet shown in accordance to FIG. 1a along section A-A with a flat or planar cross-section;

FIG. 1c is a cross-sectional view of a sorbent sheet having a square wave cross-section;

FIG. 1d is a cross-sectional view of a sorbent sheet having a curved wave cross-section;

FIG. 1e is a cross-sectional view of a sorbent sheet having a triangular wave cross-section;

FIG. 1f is a cross-sectional view of a sorbent sheet having a saw-tooth cross-section;

FIG. 1g is a cross-sectional view of a sorbent sheet having a corrugated cross-section;

FIG. 2 is a process flow diagram for an embodiment of a sorptive gas separation process employing polymeric amine sorbents or polymeric amine composite sorbents for separating a first component from a multi-component fluid stream;

FIG. 3a is a scanning electron micrograph surface view of a sorbent 20 sheet from polyethylenimine supported on porous silica at 500× magnification;

FIG. 3b is a scanning electron micrograph surface view of a sorbent sheet from polyethylenimine supported on porous silica at 10,000× magnification;

FIG. 3c is a scanning electron micrograph cross-sectional view of a sorbent sheet from polyethylenimine supported on porous silica at 5,000× magnification;

FIG. 4 is a plot of the particle size and distribution of the co-polymer of allylamine and divinylbenzene (DVB) sorbent of example 6b, wherein the y-axis shows the volume as a percentage, while the x-axis shows the particle size in micrometers;

FIG. 5a is a bar chart comparing two different sorbents and their oxidation stability after exposure to air for 1 hour at 120° C., after 1 cycle and 20 cycles;

FIG. 5b is a bar chart showing four different sorbents and their hot water stability after soaking the sorbent powders in hot water;

FIG. 6a is a scanning electron micrograph of a sorbent powder at 55,000× magnification;

FIG. 6b is a scanning electron micrograph of a cross-section of a sorbent sheet from example 8 showing the polymer particles and porosity at 55,000× magnification; and

FIG. 7 is a plot of temperature and mass of a coupon of sorbent sheet over time. The mass of the coupon is the solid plot, while the temperature is the dashed plot. The mass and temperature are shown on the right and left y-axis respectively, while time is shown on the x-axis.

### DESCRIPTION

### Definitions

Adsorbent: a porous solid material, capable of sorbing a molecule by chemisorption and/or physisorption, on and/or in the adsorbent material.

The terms “sorbent”, “adsorbent” and “absorbent” are used interchangeably herein.

The terms “sorptive”, “adsorptive”, and “absorptive” are used interchangeably herein.

Tolerant sorbent: an adsorbent which meets or exceeds the definition for at least one of a steam tolerant sorbent, an oxidation tolerant sorbent, nitrogen oxide (herein referred to as “NOx”) tolerant sorbent, and/or a sulfur oxide (herein referred to as “SOx”) tolerant sorbent.

Intolerant sorbent: an adsorbent which fails to meet or fails to exceed the required definition for at least one of a steam tolerant sorbent, an oxidation tolerant sorbent, a NOx tolerant sorbent, and/or a SOx tolerant sorbent.

Composite sorbent: a sorbent comprising two or more adsorbent materials of different composition and/or different pore structure, for example, at least one stable or tolerant sorbent and at least one unstable or intolerant sorbent, combined to form a sorbent mixture where the two or more sorbent materials can be substantially homogeneously or heterogeneously distributed within the sorbent mixture.

Sorbent sheet: self-supported sheet, active layer, or laminate, with a thickness between 0.1 and 3.0 millimeter with at least one other dimension being 100 times greater than the thickness. Sorbent sheets can be cut into ribbons where the ribbon width is at least 10 times greater than the thickness of the sheet.

Sorbent form or formed composite sorbent: a solid object containing at least one sorbent form, for example, an aggregated powder, with or without the use of a binder or sorbent support, formed into at least one millimeter sized object or larger, such as pellets, beads, irregular particles, ribbons, rings, sheet segments, which can be used in a contactor vessel or column or in an sorbent contactor, providing passages for a process fluid.

Supported composite sorbent: a composite sorbent on a sorbent support, such as, a sorbent sheet.

Steam stable adsorbent: porous solid material capable of maintaining a loss of less than 10% in adsorption capacity, adsorption energetics, and adsorption kinetics, after exposure to conditions of >95% relative humidity (herein referred as “RH”) at temperatures between 80 degrees Celsius (herein referred as “C”) and 120° C. for greater than 100 hours (herein referred as “h”).

Steam unstable adsorbent: porous solid material showing a loss of greater than 10% in adsorption capacity, adsorption energetics, and adsorption kinetics, after exposure to conditions of >95% RH at a temperature between 80° C. and 120° C. for greater than 100 h.

Steam tolerant: capable of maintaining a loss of less than 10% in adsorption capacity, adsorption energetics, and/or adsorption kinetics, after exposure to conditions of >95% relative humidity steam conditions at a temperature between 80° C. and 120° C. for greater than 100 h.

Oxidation tolerant: capable of maintaining a loss of less than 10% in adsorption capacity, adsorption energetics and/or adsorption kinetics, after exposure to air at a temperature of about 110° C. for more than 4 h.

Target cycle capacity: amount of desired target component captured during a separation cycle under steady state operation per unit mass of sorbent.

Cyclic capacity: amount of target component purified or extracted from a product stream during an adsorption-desorption separation cycle per unit mass of sorbent.

Heat capacity (herein referred as “Cp”): heat capacity of a sorbent or sorbent mixture, its support and other inactive components in thermal contact with each other in an adsorbent contactor.

Heat of adsorption: amount of energy released by removing a molecule from the gas phase and attaching it to a solid or supported liquid.

Water adsorbent material: porous solid materials which can experience greater than a 5% weight gain when exposed to a condition of greater than 60% RH.

Target compound adsorbent material: porous solid materials which can experience greater than a 1% weight gain when exposed to a condition where a feed gas stream or feed mixture is at a temperature between −10° C. to 80° C.

Thickness: smallest dimension of the three-dimensional object, for a sheet shaped material it is measured in the direction perpendicular to the plane of the sheet, for a sphere it is the diameter of the sphere, for an ring this is the difference between outer and inner radius of the ring, for an irregular particle it is the shortest distance of a line through one side of the object to the other side of the object and through the center of mass of the object.

PEI: Polyethylenimine or [CH₂CH₂NH]ₙ polymer with repeating units of iminoethylene arranged in linear or branched fashion. Linear PEIs contain all secondary amines, and branched PEIs can contain primary, secondary and tertiary amine groups.

PAA: Polyallylamine or [CH₂CHCH₂NH₂]ₙ

Domain: a fragment of a molecule or polymer, from a solubility perspective considered detached from the rest of the molecule or polymer.

Passage void fraction: void fraction of passages formed by sorbent sheets or sorbent forms within a contactor. Passage void fraction can be used interchangeably with the term channel void fraction.

Particle: a piece of material with a volume equal to or less than 1 cubic millimeter.

Particle size: a dimension of a solid particle defined if not specified as equivalent diameter of a sphere of same volume as the particle.

Film: thin layer of material deposited on a support or material near the surface of a sheet of material.

Sheet: an object with one dimension much smaller than the two other dimensions giving the object the appearance of a two-dimensional object or surface. As used in some embodiments described herein, a solid object is called a sheet when the smaller dimension defined as the shortest distance between two points on opposite sides of the object is less than on average 1% of the length of any line following the surface of the object connecting two opposing edges of the object.

Ribbon: an object with one dimension much smaller than the two other dimensions, with a large difference in length of the object relative to the two other dimensions. A ribbon can be obtained by cutting a sheet into narrow strips. As used in some embodiments described herein, a ribbon has a flattened width that is at least 20 times smaller than the flattened length and a thickness that is less than 1% of the flattened length of the object. Ribbons can be bent, warped, pleated, or corrugated, for example, to assist in the formation of flow channels when assembled into a contactor.

Insoluble: less than 100 ppm by weight of a solid material when it is dissolved in a suspension containing 1% solid per solvent at a temperature between 10° C. and 40° C., in a water solution with a pH of 5 to 9.

Generally, porous sorbent structures are disclosed. In embodiments, the porous sorbent structures can contain polymeric amine adsorbent sites, optionally supported on an inorganic porous support or integrated into a porous polymer network. In embodiments, such sorbent structures can advantageously be used in sorptive gas separation processes. More particularly, compositions and structures of such sorbent structures can be used in processes for the separation of an acid gas from a multi-component fluid stream (for example, a combustion gas stream, a flue gas stream, a process gas stream, an air stream, or other dilute source) during an adsorptive gas separation process, wherein the polymeric amine adsorbent is exposed to at least one process gas stream (for example, a feed stream and/or a regeneration gas stream) with high relative humidity, for example, above about 30% relative humidity.

Mediation of the impact of exposure of polymeric amine sorbents to high relative humidity (which can lead to a significant quantity of liquid water being adsorbed or filling some of the sorbent pores) during at least part of a separation process cycle is discussed.

Novel polymeric amine sorbents that have high sorption capacity for at least one component and have high stability and/or tolerance towards, moisture, oxygen (herein referred to as “O₂”) and carbon dioxide (hereinafter “CO₂”) are described herein. In some embodiments, such polymeric amine sorbents can be supported on support materials with high pore volumes.

Polymeric amines with high primary and secondary amine content are typically water-soluble polymers and are known to become mobile or leach from a sorbent support and/or sorptive contactor when exposed to high relative humidity. As described herein, chemical modification of an amine polymer can be used to modify the polar nature of the polymeric amine, reducing the tendency for the amine to be leached out and/or leading to the immobilization of the amine inside a porous solid support.

Use of known supported polymeric amine adsorbents has generally been restricted to applications where the adsorbents are exposed only to dry or low relative humidity conditions and/or are protected from exposure to high relative humidity or water, such as in gas chromatography applications. As new applications for separation of multi-component gas mixtures containing water, and/or sorptive processes using steam or hot water for regeneration evolve, a need to develop more stable and robust sorbents was identified.

Co-polymerized amine monomers with large rigid co-polymers favoring the formation of a porous network structure that present similar benefits in acid gas removal under moist conditions are also disclosed.

Preferred macroscopic arrangements are described herein of polymeric amine sorbents in two-dimensional structures used to build practical contactors with reduced flow resistance and with enhanced acid gas recovery.

One aspect of a sorbent is the macroscopic or three-dimensional structure of the sorbent, which in some embodiments can exhibit a porous network geometry comprising a primary pore network with interconnected primary pores and a secondary pore network with interconnected secondary pores, where the primary pore network is interconnected with the secondary pore network. In some embodiments, the primary pores have average diameters in the range between about 1 micron to about 30 microns, and the secondary pores have average pore diameters in a range between about 10 to about 200 nanometers.

Some intensified rapid cycle sorptive gas separation processes use a moisture swing desorption mechanism to regenerate solid sorbents. Such sorptive gas separation processes can be used for separating an undesired component, for example, CO₂, from a gas mixture, to help address the challenges of greenhouse gas (GHG) emissions and associated climate change. Examples of such processes are described in International Publication Patent Application WO 2017/165974.

Polymeric sorbents with a high cyclic capacity for adsorption and desorption of a target molecule, as well as desirable chemical and structural stability of the active component when exposed to its process environment, and which preserve both active site function as well as kinetically facile access to those sites is desired.

The durability of a sorbent material to cyclic exposure to a high relative humidity, condensation, water, and/or oxygen, is critical in some applications as disclosed above. Embodiments of polymeric amine sorbents with stable active sorption sites within a porous structure are described herein, where a target gas component can be easily introduced and separated.

### EMBODIMENTS

In embodiments, a solid polymeric amine sorbent can have an average molecular weight greater than about 2000 Dalton, be insoluble in water, and be configured in particles or a film having a porous network. In embodiments, a solid polymeric amine sorbent can comprise a first sorbent domain which is soluble in water (soluble domain), and a second sorbent domain which is insoluble in water (insoluble domain). In embodiments, a solid polymeric amine sorbent can also have greater than about 6% mass fraction of nitrogen relative to the total mass of polymer. In other embodiments, the solid polymeric amine sorbent can contain primary, secondary, and tertiary amine groups. In some embodiments, the tertiary amine group represents less than about 20% mole fraction of nitrogen in the polymeric amine sorbent. In some embodiments, the primary and secondary amine groups represent greater than about 80% mole fraction of nitrogen in the polymeric amine sorbent. In some embodiments, a solid polymeric amine sorbent can have an average pore volume greater than about 0.2 ml/g, or preferably an average pore volume in an average pore volume range of about 0.3 ml/g to about 1.5 ml/g. In embodiments, a solid polymeric amine sorbent can have an average BET (Brunauer, Emmett and Teller) surface area within a range of about 4 m²/g to about 500 m²/g, or more preferably about 20 m²/g to about 300 m²/g, where the surface area is measured, for example, using the BET technique with liquid nitrogen.

In embodiments, a solid polymeric amine sorbent can have an average pore diameter in a range of about 10 to about 200 nanometers, for example, measured using nitrogen adsorption isotherms. In some embodiments, a solid polymeric amine sorbent is in the form of a particle with an average particle size in a particle size range of about 0.2 to about 40 micrometers. In some embodiments, the solid polymeric amine sorbents described herein are unsupported forming a porous solid sorbent, or the sorbents can be configured on and/or in an inorganic porous support. In some embodiments, the polymeric amine sorbents described herein can be formed into a self-supporting active layer comprising with at least about 75% by weight of polymeric amine sorbent where the active layer has a thickness in a range of about 0.1 mm to about 3 mm, or particularly about 0.2 mm to about 1 mm.

In embodiments, a solid polymeric amine sorbent can be configured into a sorbent layer or other sorbent form having a porous network geometry combining a primary pore network of interconnected primary pores which are also interconnected to a secondary pore network. In certain embodiments, the primary pore network has an average primary pore diameter range of about 1 micron to about 30 microns, and the secondary pore network has an average diameter range of about 10 nanometers to about 200 nanometers.

Such sorbent structures can be formed from porous particles with average pore diameters of about 10 nanometers to about 200 nanometers and average particle sizes in a range of about 0.2 micrometers to about 40 micrometers. Upon fabrication of the sorbent layer or other sorbent form, imperfect stacking of the particles (which can be irregularly shaped) can create a network of pores between particles, having an average primary pore diameter in an average primary pore diameter range of about 1 micron to about 30 microns.

This hierarchy of interconnected pores can facilitate rapid exchange of gas between the sorbent and a process stream.

In embodiments, a solid polymeric amine sorbent can be a polymeric amine composite sorbent that has an average molecular weight greater than about 2000 Dalton, be insoluble in water, and be configured in particles or films comprising a porous network. In embodiments, the polymeric amine composite sorbent can comprise a first sorbent domain which is soluble in water (soluble domain), and a second sorbent domain which is insoluble in water (insoluble domain). In some embodiments, a solid polymeric amine composite sorbent has greater than about 6% mass fraction of nitrogen relative to the total polymer mass. In embodiments, a solid polymeric amine composite sorbent contains primary, secondary, and tertiary amine groups. In some embodiments, the tertiary amine groups represent less than about 20% mole fraction of nitrogen in the polymeric amine composite sorbent. In some embodiments, the primary amine and the secondary amine groups represent greater than about 80% mole fraction of nitrogen in the polymeric amine composite sorbent.

In embodiments, a polymeric amine composite sorbent can comprise a polyethylenimine with a molecular weight between 2,000 and 12,000 Dalton reacted with molecules containing a C₁₀ to C₁₆ alkyl terminal chain and an electrophilic group capable of binding to a primary or secondary amine, to form a functionalized polymer. In embodiments, a functionalized polymer is deposited on a porous support with an average pore volume between 0.3 to 1.5 ml/g, an average BET surface area in a range of about 4 m²/g to about 500 m²/g, or more preferably about 20 m²/g to 300 m²/g, and an average pore diameter in a range of about 10 to 200 nanometers. Examples of such porous support materials include silica, alumina, zirconia, clays, aluminosilicates their analogues and combinations thereof as long as the pore size is sufficiently large, e.g. greater than 10 nm. The surface area can be measured using the BET technique with liquid nitrogen.

In embodiments, the polymeric amine composite sorbent composite can further comprise an ethoxide. The solid composite sorbent can be unsupported or configured on and/or in an inorganic porous support. In embodiments of a polymeric amine composite sorbent, the polymeric amine can be at least one of a co-polymer of vinyl amine and divinyl monomer containing primary and or secondary amine groups with an interconnected porous structure

In embodiments, the polymeric amine is at least one of:
a grafted alkylamine supported on a porous support where the porous support has an average pore volume between about 0.3 ml/g to about 1.5 ml/g, or preferably about 0.7 ml/g to about 1.5 ml/g and the grafted function on the amine group comprises hydrophobic groups,
a polyethylenimine functionalized with C₁₀ to C₁₆ alkyl alcohols, and supported on porous organic or inorganic solid support, and/or
a polyethylenimine functionalized by reaction with an alkyl-epoxide.

The porous network polymeric amine composite sorbent can be formed into a self-supporting active layer comprising at least about 75% by weight of polymeric amine composite sorbent where the active layer has a thickness in a range of between about 0.1 mm to about 3 mm, or particularly about 0.2 mm to about 1 mm.

In embodiments, a polymeric amine composite sorbent can comprise a co-polymer of a vinyl amine and a divinyl monomer with primary and or secondary amine groups and an interconnected porous structure. In embodiments, the polymeric amine composite sorbent comprises a co-polymer of allylamine and divinylbenzene (DVB).

In embodiments, a polymeric amine composite sorbent can comprise a co-polymer of propylenimine and divinylbenzene, and/or a co-polymer of ethylenimine and divinylbenzene.

In embodiments, the composite sorbents described above can be synthesized by controlling reaction stoichiometry, reaction temperature and solvent composition of the electrophilic long alkane terminated reagent and the PEI. In embodiment, during synthesis of the low water solubility PEI polymer derivative or polymeric amine composite sorbent, a fraction of primary or secondary amine reacted with the electrophilic molecule can be greater than about 5% and less than about 40%.

Examples of the resulting sorbents and composite sorbents demonstrated a CO₂ sorption capacity greater than 80% of the native PEI polymer under the same conditions are described in greater detail below. However, briefly, Examples 1 and 2 provide CO₂ adsorption capacity for the sorbent powder and sorbent sheet demonstrating a decrease in CO₂ capacity of less than 15% when incorporating the sorbent powder into a sorbent sheet. This difference can be explained by the addition of non-CO₂ adsorbing mass into the sorbent sheet composite.

Example 3 shows that an insufficiently long alkyl chain for the Alkyl-epoxide functionalizing agent fails to prevent the loss of CO₂ capacity for the composite after soaking in pure water. Similarly, a minimum molecular weight for the Polyethylenimine is required to prevent measurable leaching of amine containing polymer outside the silica support. While under cyclic adsorption/desorption conditions for separating CO₂ using a fast cycle with steam regeneration large film or pore filling by water doesn't typically occur, however, slow migration of the amine was observed for sorbent compositions that are failing the liquid water exposure test. Three 1000 h [or about 50,000 adsorption/desorption cycles] test have been conducted with contactors fabricated respectively from PEI 2K—with no Epoxidation, PEI—2K with C4-Epoxy-alkyl functionalization and PEI 10K with C12-Epoxy-alkyl functionalization. The results of these tests correlated with the results of the pass/fail table presented in Example 3.

The sorption capacity of the composite sorbents is typically greater than about 2 mmol/g under typical input gas operating conditions with exposure to a stream containing 15% CO₂ in nitrogen at 50° C. Furthermore, the disclosed composite sorbents also demonstrate fast adsorption kinetics with greater than about a 0.03 mmol/g/s initial adsorption rate when exposed to 15% CO₂ in nitrogen at 50° C. with an average particle size of the sorbent of less than 30 microns as derived from TGA data weight gain slopes. Within a sorbent contactor, the sorbent sheets exposed to high flux of CO₂ per g of sorbent exhibit a similar order of magnitude for their average kinetic rates as indicated by the productivity rate in examples 5 and 11. However, the local kinetic rate for CO₂ adsorption is at least one order of magnitude faster as compared to the overall kinetic rate as limited by the feed CO₂ flux.

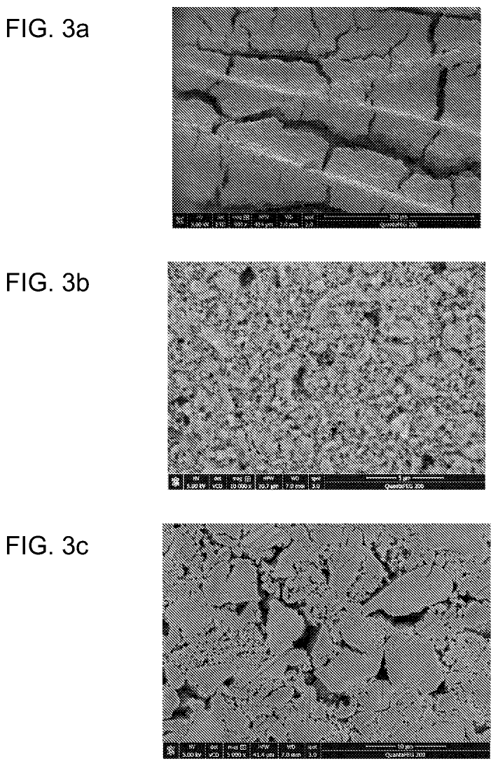

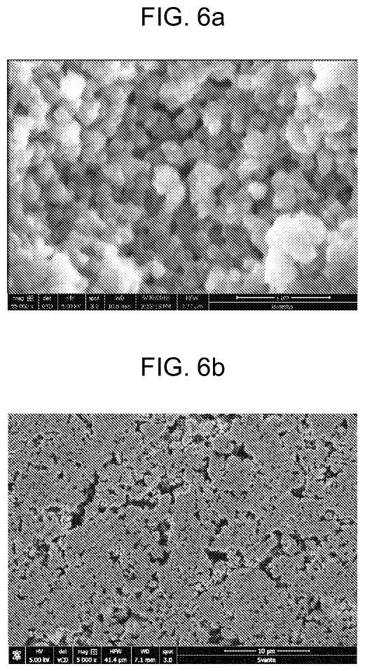

Examples of sorbent sheets comprising of composite sorbents containing greater than about 75% by weight of amine containing sorbent particles with an average particle size in a range of about 0.2 to about 40 micrometers described herein demonstrated fast CO₂ adsorption kinetics similar to thin layers of loose powder. FIGS. 3a and 6b show scanning electron microscope pictures of sorbent sheets using two different type of amine sorbent powder where the predominant material in the sheet is the sorbent powder.

In embodiments, polymeric amine sorbents and polymeric amine composite sorbents have a CO₂ equilibrium capacity at 50° C. under 15% CO₂ feed mixture per unit heat capacity of the sorbent of between 15 to 40 cc CO₂/(J/K) with a kinetic adsorption rate of greater than about 0.03 mmol/g/s when the sorbent (regenerated and ready for sorption) is in contact with a 15% CO₂ mixture at a temperature between 30° C. and 50° C. Examples 2 and 8 illustrates sorbent sheets fabricated from two different sorbent materials containing amine polymers. The heat capacity (Cp) for the sorbent sheet presented in examples 2 and 8 are between 1.7 and 2 J/gK, leading to greater than 15 cc CO₂ capacity/(J/K) sorbent sheet heat capacity. This ratio strongly impacts the amount of energy used in the regeneration of the sorbent when desorbing CO₂. A larger ratio improves the economy of the process if no other parameters are changed.

In embodiments, polymeric amine composite sorbents have a heat of adsorption for CO₂ between 70 and 120 kj/mol of CO₂ adsorbed.

The heat of CO₂ adsorption also impacts the energy cost of regenerating the sorbent. Lower heats of adsorption are preferred, however the selective adsorption of CO₂ requires a sufficient thermodynamic driver to remove CO₂ from a low CO₂ partial pressure feed.

In some embodiments, less than 10% of the sorption capacity of the polymeric amine composite sorbent is lost after 50,000 cycles of operation, where the operation includes a regeneration step under hot and moist conditions, for example, at temperatures between 90° C. and 130° C. with a relative humidity in a range from 50% to 100%.

In some embodiments, functional amine groups form greater than about 50% of the amine groups present in the amine polymer, where the functional amine groups can comprise at least one of:
R₁-CH₂—NH₂
R₁-C₂H₄—NH₂
R₁-COR₂-CH₂—NH₂
R₁—NH-R₂
R₁—NH-CH₂-COR₂.
where R₁ and R₂ is one of: hydrogen, a polyamine, a copolymer of vinyl amine and a rigid divinyl spacer group, an alkane, or a 10 to 16 carbon linear alkane chain.

In some embodiments, the polymeric amine sorbent can be formed as a co-polymer from a short (with a molecular weight less than 100 Dalton) vinyl amine monomer reacted with a long (with a molecular weight greater than 100 Dalton) divinyl monomer.

A measure of process intensity of a sorbent system can be expressed as the metric tons per day of a gas component captured from a gas mixture per metric ton of sorbent (herein referred as “TPD/MT”). Key parameters affecting a process intensity include a sorbent's capacity and kinetics. A sorbent with a high sorption capacity and fast kinetics is typically desirable for increasing process intensity. Examples of productivity for two different sorbent contactors operating under fast cyclic conditions are provided in Examples 5 and 11 discussed below.

In embodiments, contactors comprising sheets of the novel sorbent, polymeric amine sorbents or polymeric amine composite sorbents demonstrated a process intensity of greater than 30 metric tons per day of CO₂ captured from a gas mixture with a 10% CO₂ concentration, per metric ton of sorbent when cycled between adsorption and desorption steps in less than 2 minutes.

### Sorbent Sheets or Sorbent Forms and Separators or Contactors

Embodiments of the present invention include sorptive contactors having a solid sorbent, particularly a polymeric amine sorbent, and more particularly a polymeric amine composite sorbent, for separation of components from a multi-component gas stream in a sorptive contactor. The sorptive contactors can comprise a plurality of sorbent sheets, or sorbent forms, stacked or otherwise placed adjacent to one another. In an embodiment the sorptive contactor is a stack of a plurality of sorbent sheets placed one on top of another, with at least one passage being formed between two adjacent stacked sorbent sheets or a pair of sorbent sheets for permitting a fluid to flow through the at least one passage and thus, through the contactor, with the fluid coming into contact with the sorbent sheets or sorbent forms. Each sorbent sheet or sorbent form can comprise a solid sorbent, such as a polymeric amine sorbent or a polymeric amine composite sorbent as described above. In embodiments, at least 75% by weight of the sorbent in the sorbent sheet or sorbent form is from the polymeric amine sorbent or a polymeric amine composite sorbent, the sorbent sheet or sorbent form having a thickness in a range of about 0.1 mm to about 3 mm or preferably about 0.2 mm to about 1 mm. In embodiments, the polymeric amine has greater than about 5% by weight of nitrogen from a primary or a secondary amine functional group relative to the weight of the polymer. In embodiments, each sorbent sheet or sorbent form can have a density in a range of about 0.2 g/cm³ to about 0.8 g/cm³.

In embodiments, the polymeric amine composite sorbent can be formed as a co-polymer from a short (having a molecular weight less than 100 Dalton) vinyl amine monomer reacted with a long (having a molecular weight greater than 100 Dalton) divinyl monomer.

In embodiments, the polymeric amine can be formed from the reaction of a water-soluble polymeric amine with a molecular weight of greater than 2000 Dalton with long chain alkyl (8 carbon or greater) ligands.

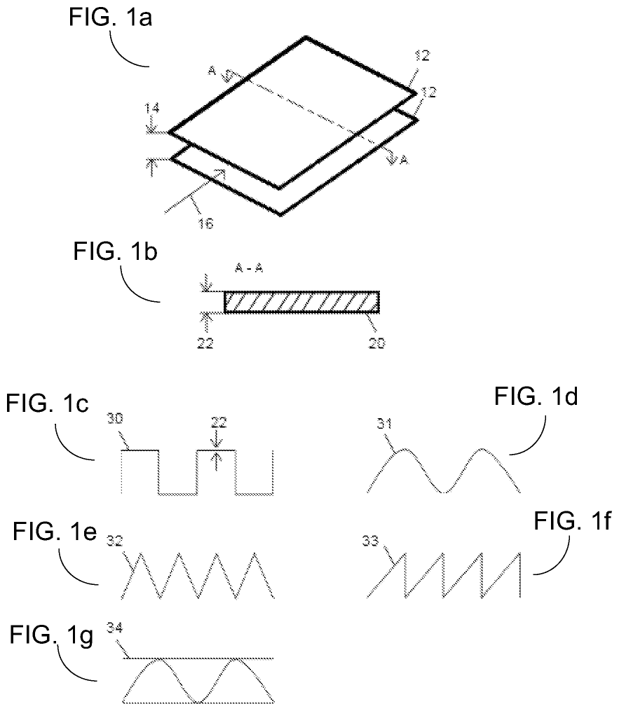

With reference to FIG. 1a, it illustrates an exemplary plurality of a sorbent forms or a set of two sorbent sheets 12, that can comprise a polymeric amine sorbent or a polymeric amine composite sorbent, where the plurality of sorbent sheets 12 are stacked adjacent to one another (or on top of one another) forming a void or a passage 14 therebetween for permitting a fluid to flow through passage 14 between and in contact with each of the plurality of sheets 12,12. Arrow 16 shows a direction of flow of the fluid, for example, a feed stream, in passage 14. Sorbent sheets 12 as shown can be configured in a form of a substantially flat plane, a flat sheet, or planar configuration. A cross-section A-A of a sorbent sheet 12 is shown in FIG. 1b as a sheet cross-section 20 (not shown to scale or aspect ratio relative to sorbent sheet 12) having a sorbent form thickness or a sorbent sheet thickness 22. In alternative configurations, sorbent sheets or a sorbent forms can have a thickness 22 and be non-planar. For example, the sheet can be corrugated to have alternative cross-sectional shapes including, as shown in FIG. 1c, a square wave 30 cross-section, a curved wave or a sine wave 31 cross-section in FIG. 1d, a triangle or triangular wave 32 cross-section as shown in FIG. 1e, a saw tooth or a saw tooth wave 32 cross-section as shown in FIG. 1f, or as a corrugate or corrugated 34 cross-section stacked with alternating planar and corrugated sheets as shown in FIG. 1g. A thickness of a sorbent form or a sorbent sheet can be calculated by dividing a volume by an area of the sorbent form or sorbent sheet. The size, shape and aspect ratio of the cross-section can be configured selectively to be suitable for a particular application.

In embodiments, a sorptive contactor can have an enclosure or housing to substantially enclose a plurality of sorbent sheets or sorbent forms and at least one passage. The enclosure or housing can have at least one inlet port fluidly connected to the at least one passage for admitting a gas or fluid stream into the sorptive contactor, and at least one outlet port fluidly connected to the at least one passage for recovering or exhausting a product stream from the sorptive contactor. In embodiments, the sorptive contactor can be configured with a plurality of sorbent sheets or sorbent forms stacked on top of one another, forming repeatable stackable elements with at least one passage between sorbent sheets or forms. In embodiments, there can be passages between sorbent sheets or forms for forming a plurality of passages in the sorptive contactor. In embodiments, the plurality of passages are substantially parallel to each other. In embodiments the plurality of passages may not substantially parallel to each other.

In embodiments, the sorptive contactor can have one or more spacers for creating and/or maintaining the at least one passage between the sorbent sheets or sorbent forms. The spacer can be a separate component placed between each of the pair of sorbent sheets. In embodiments, some of the sorbent sheets or sorbent forms can have features or protuberances on them or can have a cross-sectional geometry or shape which is non-planar including, for example, as illustrated in FIGS. 1c to 1g to function in substantially the same way as the one or more spacers. That is to create and/or maintain a spacing between each of the sorbents sheets and the at least one passage.

The protuberances can be made with a protuberance material which is substantially the same as a sorbent sheet or sorbent form material. For example, the sorbent sheet can be embossed.

The sorptive contactor can have one or more sorbent sheets or sorbent forms where a sorbent sheet or sorbent form can be formed into or configured with at least one of a flat sheet, a pleated sheet or a corrugated sheet.

Spacers which are separate components and made of different materials from the sorbent sheet or form, can be attached to at least one sorbent sheet or form, or placed between sorbent sheets or forms during assembly of the sorptive contactor. A sorptive contactor can comprise sorbent sheets or sorbent forms where spacers are printed on to the sorbent sheet or sorbent form.

In embodiments, the sorptive contactor can have a passage void fraction (one or more passages created by the sorbent sheets or sorbent forms in a sorbent contactor, also known as “a channel void fraction”), in a void fraction range of about 20% to about 80% void fraction, or preferably about 30% to about 75% void fraction.

In embodiments, the sorbent sheets or sorbent forms contained in the sorbent contactors disclosed herein comprise a porous network geometry having a primary pore network of interconnected primary pores which are also interconnected to a secondary pore network, where the primary pore network has an average pore diameter of about 1 micron to about 30 microns, and the secondary pore network has an average pore diameter range of about 10 nanometers to about 200 nanometers.

Such pore structures can be obtained by forming the sorbent sheets or sorbent forms from porous particles of the compositions disclosed herein with an average particle size in a range of about 0.2 micrometers to about 40 micrometers.

During fabrication of the sorbent layer, imperfect stacking of irregular shaped particles can create a network of pores between particles having primary pore diameters with an average diameter range of about 1 micron to about 30 microns.

This hierarchy of interconnected pores can facilitate the rapid exchange of gas between the sorbent layer and the process stream in passages between the sorbent layers or sorbent forms.

In embodiments, the sorptive separator can comprise at least one sorptive contactor as described above. In certain embodiments, the sorptive separator can have an enclosure or housing to substantially enclose the at least one sorptive contactor or plurality of sorptive contactors, the enclosure or housing having at least one inlet port fluidly connected to the at least one passage of a sorptive contactor for admitting a gas or fluid stream into the sorptive separator and sorptive contactor, and at least one outlet port fluidly connected to the at least one passage of the sorptive contactor for recovering or exhausting a product stream from the sorptive contactor and sorptive separator.

Embodiments of the present invention can include a sorbent bed with a solid sorbent, particularly a polymeric amine sorbent, and more particularly a polymeric amine composite sorbent, for separation of a multi-component gas stream. The sorptive bed can comprise a vessel, an inlet port on the vessel, an outlet port on the vessel, and a plurality of a sorbent pellets comprising a solid sorbent, such as a polymeric amine sorbent or a polymeric amine composite sorbent, as described herein. The polymeric amine sorbent or a polymeric amine composite sorbent can be configured on and/or in a sorbent support. The sorbent bed can be a fixed bed or a fluidized bed.

### Process of Use of Solid Sorbents

Solid sorbents such as polymeric amine sorbents or solid sorbent compositions with distinct sorbent and/or sorption properties disclosed herein can be used for the purpose of separating a first component (for example, an acid gas, carbon dioxide, a nitrogen oxide and/or a sulfur oxide) from a multi-component gas stream for industrial or utility deleterious effluent reduction, and for providing a concentrated stream of an acid gas component, such as, CO₂, which can be further utilized for sequestration or other industrial usage.

In embodiments, a sorbent separator, a sorbent bed and/or a sorbent contactor comprising a polymeric amine sorbent, and/or a polymeric amine composite sorbent, having distinct sorbent and sorption propertie, can be used in a sorption process for separating a first component from a multi-component gas stream.

In embodiments, a sorptive gas separation process for sorptive gas separation of a multi-component fluid stream comprising at least a first component (which can comprise for example, carbon dioxide, a nitrogen oxide and/or a sulfur oxide) and a second component is provided. In one such embodiment, the sorptive process can separate at least a portion of the first component from the multi-component fluid stream.

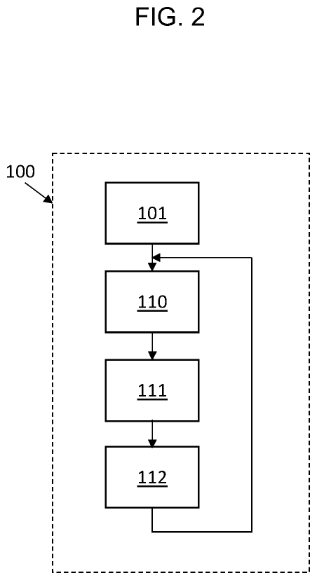

FIG. 2 illustrates an embodiment of a sorptive gas separation process 100 for separation of a multi-component fluid stream comprising at least a first component and a second component.

As shown in FIG. 2, an initial step 101 includes providing a sorptive gas contactor having at least a polymeric amine sorbent, and/or a polymeric amine composite sorbent as described herein. The process 100 employs a sorptive gas contactor comprising a plurality of sorbent sheets or sorbent forms, as described herein, stacked on top of one another for creating a passage between each pair of adjacently stacked sorbent sheets or sorbent forms, creating one or more channels or passages for permitting a fluid to flow through the contactor. In embodiments, a plurality of spacers can be placed or otherwise positioned in between each of the plurality of sorbent sheets for creating the passage therebetween.

In embodiments, the sorptive gas contactor can have a plurality of sorbent sheets or forms, each of the plurality of sorbent sheets forming a passage with an adjacent sorbent sheet. In embodiments, each of the sorbent sheets can have a polymeric amine sorbent, and/or a polymeric amine composite sorbent as described above. In embodiments, at least 75% by weight of the sorbent on a sorbent sheet or form is a polymeric amine sorbent or a polymeric amine composite sorbent. In some embodiments, the sorbent sheets or forms can have a thickness in a range of about 0.1 mm to about 3 mm or preferably about 0.2 mm to about 1 mm, and a density of about 0.2 g/cm³ to about 0.8 g/cm³. An example of a thickness of a sorbent sheet is illustrated in FIG. 1b as thickness 22.

A multi-component gas stream (for example, a combustion gas stream, a flue gas stream, a process gas stream, an acid gas stream, or an air stream) having at least a first component (for example, carbon dioxide, an oxide of sulfur, or an oxide of nitrogen) and a second component (for example, nitrogen), can be used as a feed stream and admitted into the contactor during a sorbing step 110. In embodiments, the multi-component gas stream can also comprise moisture. As the multi-component gas stream flows through the contactor, it contacts the polymeric amine sorbent, and/or a polymeric amine composite sorbent, and at least a portion of the first component of the multi-component gas stream sorbs in and/or onto the sorbent. In embodiments, the multi-component gas stream can be admitted and/or come in contact with the polymeric amine sorbent, and/or a polymeric amine composite sorbent at a pressure between about 1 bar absolute and about 2 bar absolute. In embodiments, the feed stream can be admitted into the contactor at a temperature between about 10° C. and about 90° C. Although not specifically shown, remaining components of the multi-component stream, or those components that are not sorbed in and/or onto to sorbent material, for example, the second component, such as nitrogen, flows through the contactor and exits from the contactor in the form a first product stream, and be recovered.

In some embodiments, during a sorbing step 110, the polymeric amine sorbent and/or polymeric amine composite sorbent can be exposed to a first relative humidity which can be equal to or greater than about 20% relative humidity (RH). In embodiments this RH can be as measured in the sorbent sheets or forms, particularly within the pore volume of the sorbent sheets or forms when the gas in the pores and the sorbent are approximately in thermal equilibrium.

Thermal equilibrium can be defined as for example when a temperature of the gas in the pores and a temperature of the sorbent is at a temperature differential of equal to or less than about 2 degrees kelvin.

In embodiments, during sorbing step 110, the polymeric amine sorbent and/or polymeric amine composite sorbent, and/or contactor is at a sorption temperature. Sorbing step 110 can be terminated and a subsequent step such as a regenerating step 111 can be initiated prior to or when the polymeric amine sorbent or polymeric amine composite sorbent reaches a pre-determined sorption capacity and/or prior to or during breakthrough of the first component in the first product stream.

In embodiments, the first product stream is at least periodically depleted in the first component relative to the feed stream and also comprises the second component, such as nitrogen. In some embodiments, the first product stream is also enriched in the second component relative to the feed stream. In embodiments, the first product stream is recovered from the contactor during a regeneration step.

During the regenerating step 111, at least a portion of the first component sorbed in and/or onto the polymeric amine sorbent, and/or polymeric amine composite sorbent can be desorbed, by at least one of a temperature swing mechanism, and a partial pressure swing mechanism, to form a second product stream. In embodiments, during regenerating step 111, the polymeric amine sorbent and/or polymeric amine composite sorbent is exposed to and/or in contact with a regeneration stream that increases a relative humidity in the contactor to a second relative humidity which is equal to or greater than the first relative humidity. In embodiments, the second relative humidity is greater than the first relative humidity or is about 20% relative humidity as measured in the pores of the sorbent when the gas in the pores and the sorbent approximately in thermal equilibrium, such as, when a temperature of the gas in the pores and a temperature of the sorbent is at a temperature differential of equal to or less than about 2 degrees Kelvin.

During regenerating step 111, the polymeric amine sorbent and/or polymeric amine composite sorbent, and/or contactor can reach a regeneration temperature, where the regeneration temperature is greater than a sorption temperature.

In embodiments, a first regeneration stream comprising a third component, for example, water or steam, can be admitted into the contactor, be directed to contact the polymeric amine sorbent, and/or polymeric amine composite sorbent and to flow through the contactor. The first regeneration stream can be actively or passively controlled to have a partial pressure of steam equal to or greater than about 0.3 Bar absolute, and/or admitted into the contactor having a partial pressure of steam equal to or greater than about 0.3 Bar absolute. As a result, at least a portion of the first regeneration stream or third component can sorb in and/or onto the sorbent, generating heat of sorption. This heat of sorption is a result of the phase change undergone by water, for example, changing from the gas phase (for example, steam) into the liquid phase (for example, liquid water) or into an adsorbed state on a surface of a solid (physisorbed).

In embodiments, the first regeneration stream consists mainly of steam. This is a preferred embodiment in applications and/or processes where it is desirable to separate and recover a product stream containing a first component, for example, an acid gas or CO₂, at high purity. In other embodiments, the first regeneration stream comprises a mixture of steam and a first component, for example, an acid gas component such as CO₂.

In an embodiment, the regeneration stream is a steam stream at a pressure between 30 kPa and 120 kPa absolute with a temperature between 60° C. and 110° C.

The structure formed of a porous, thin sheet with porous solid sorbent material, that is also stable to steam and liquid water, enables a fast adsorption desorption process for CO₂ separation from flue gas or other CO₂ containing gas including ambient air, i.e. Direct Air Capture (DAC). Examples 5 and 11 are provided hereinbelow to illustrate the fast sorption/desorption kinetic capability demonstrated. With a productivity of greater than 10 TPD/T sorbent, a large amount of CO₂ containing gas is contacted with the solid sorbent in a short amount of time.

Typical contact time for the CO₂ containing gas flowing through the structure contactor is less than 1 second, or less than 0.5 seconds and more preferably less than 0.2 seconds. The high recovery rate for CO₂ is indicating that most of the sorbent material is accessible to the inlet CO₂ within a fraction of a second. The present invention combines the benefit of the structure sorbent design disclosed in PCT patent application WO2021/240476A1, with the benefit of a tailor-made amine-based sorbent powder to enable CO₂ capture at low CO₂ concentrations (below 10% CO₂) down to 400 ppm CO₂ in air (DAC) while providing enhanced lifetime for the solid sorbent in the application using a steam addition step for fast regeneration.

In an embodiment, the capture cycle time is less than 120 seconds, preferably less than 60 seconds, and more preferably less than 40 seconds.

In embodiments, the heat of sorption resulting from the sorption of water onto the polymeric amine sorbent and/or a polymeric amine composite sorbent can be used as at least a portion of a heat of desorption for desorbing at least a portion of the first component sorbed in and/or onto the sorbent. The desorbed first component along with other components in the gaseous phase can form a second product stream. Thus, in some embodiments, the second product stream can be at least periodically enriched in the first component relative to the feed stream. That is, a concentration of the first component desorbed from the sorbent material in the second product stream can be greater than a concentration of the first component in the multi-component stream. The second product stream can then be exhausted or recovered from the contactor.

In embodiments, in a sorptive gas separation process employing a contactor comprising a polymeric amine sorbent and/or a polymeric amine composite sorbent as disclosed herein, and where steam is employed as a regeneration stream, and/or a sorptive gas separation process where water can sorb on and/or in a sorbent sheet, leaching or vaporization of amine from the sorbent and/or sorbent sheet is reduced or substantially eliminated.

In embodiments, during regenerating step 111, at least a portion of the first component sorbed in and/or onto the polymeric amine sorbent and/or polymeric amine composite sorbent can be desorbed by a pressure swing mechanism, or a pressure swing mechanism in combination with a temperature swing mechanism, and/or a partial pressure swing mechanism.

In embodiments, during a conditioning step 112, components, for example, the third component such as water, sorbed on and/or in the polymeric amine sorbent and/or polymeric amine composite sorbent can be desorbed from the sorbent by at least one of a temperature swing mechanism, and a partial pressure swing mechanism, to form a third product stream. In a preferred embodiment, during conditioning step 112, the polymeric amine sorbent and/or polymeric amine composite sorbent is subjected to or exposed to a third relative humidity, where the third relative humidity is less than the second relative humidity. Exposing the sorbent to a swing or reduction in relative humidity during conditioning step 112 relative to regenerating step 111 by introducing a conditioning stream into the sorbent contactor, causes the sorbed moisture on and/or in the sorbent to desorb which can then form at least a portion of a third product stream. In embodiments, the conditioning stream is admitted into the contactor where the conditioning stream then contacts the polymeric amine sorbent and/or polymeric amine composite sorbent, the conditioning stream having a third relative humidity, where the third relative humidity is less than the second relative humidity. The conditioning stream can be, for example, at least one of an air stream, an inert gas stream, and/or a nitrogen stream. Thus, in some embodiments, the third product stream can be at least periodically enriched in the third component relative to the conditioning stream. Components desorbed from the sorbent during conditioning step 112, can form the third product stream which can be exhausted or recovered from the contactor.

In other embodiments, desorption of the third component or water sorbed on and/or in the sorbent can be performed or assisted by applying a vacuum and reducing a pressure within the contactor to a pressure below a saturation pressure of the third component, steam, or water, within the contactor.

Additional optional subsequent steps (not shown in the FIG. 2) can follow, for example, a cooling step where a temperature of the polymeric amine sorbent and/or polymeric amine composite sorbent can be reduced prior to repeating sorbing step 110. The cycle of sorbing step 110, regenerating step 111, optional conditioning step 112 (and optional subsequent steps) can be repeated as desired.

In embodiments, a sorptive gas separation process for separating at least a first component from a multi-component gas stream can comprise providing a contactor as described herein, admitting the multi-component gas stream as a feed stream into the sorbent contactor via an inlet port, sorbing at least a portion of the first component from the feed stream on the polymeric amine sorbent, recovering a first product stream at least periodically enriched in a second component relative to the feed stream from the sorbent contactor via an outlet port, admitting a first regenerating stream optionally with a steam content greater than 80% (mole fraction) purity and a partial pressure of steam equal to or greater than about 0.3 Bar absolute into the sorbent contactor, sorbing steam or water on the polymeric amine sorbent and/or polymeric amine composite sorbent and optionally generating a heat of sorption or condensation, optionally where the amount of energy released when the water sorbs onto the sorbent is greater than the energy desired to desorb the first component from the polymeric amine sorbent and/or polymeric amine composite sorbent, desorbing at least a portion of the first component sorbed on the sorbent and forming a second product stream at least periodically enriched in the first component relative to the feed stream, recovering the second product stream from the sorbent contactor, and optionally desorbing the water sorbed on the sorbent optionally by admitting an conditioning stream, for example, an air stream, an inert gas stream, and/or a nitrogen stream having a third relative humidity where the third relative humidity is less than a second relative humidity, and/or by applying a vacuum and reducing a pressure within the contactor to a pressure below a saturation pressure of at least one of the third component, steam and/or water within the contactor.

Employing a polymeric amine sorbent and/or a polymeric amine composite sorbent as disclosed above, in a sorptive gas separation process, in particular a sorptive gas separation process where during a regeneration step steam is employed in a regeneration stream and/or a sorptive gas separation process where water can sorb on and/or in a sorbent sheet, offers the advantages of reducing the leaching or vaporization of amine from the sorbent resulting in increasing the durability of the sorbent and contactor.

### EXAMPLES

### Example 1a: Supported Amine Polymer

### Preparation of PEIDS.

High pore volume silica [1.2 ml/g] was mixed at 20° C. with PEI polymer (10K Dalton) that had been functionalized through reaction with 1,2 Epoxy-dodecane (ED) in Isopropanol (IPA) for an hour. Additional inorganic anti-oxidant salt dispersed in water was added at 1.6% weight fraction of the dried sorbent powder dissolved in water resulting in an IPA/Water mixed solvent mass ratio of 9/1 prior to Silica addition. Finally, high pore volume Silica was slowly mixed into the solution to achieve the following mass ratio PEI/ED/SiO₂ of 85/51/100 in the dried powder. The slurry formed was stirred at room temperature for another 20 hours. The solvent was then removed at 60° C. in a rota-vaporator. The powder recovered was placed in a drying oven at 100° C. for one hour. The recovered power was then tested for CO₂ capacity with a TGA instrument, the measured CO₂ sorption capacity for the powder was 44±2 cc/g of CO₂ at 50° C. with 10% CO₂ in a balance Nitrogen feed.

### Example 1b: Sorbent Sheet Preparation

The powder of Example 1a was mixed with water and a polymeric binder and a dispersion agent in the weight ratio of water/powder/binder/dispersant of 64.8/32/2.5/0.7. The binder was Styrene Acrylic binder added to the slurry as a 45 wt % solution, the dispersant was mixture of defoamer and surfactant to stabilize the suspension.

The suspension was placed in a high shear mixer for 1 h, and then placed into a ball mill drum with stabilized zirconia grinding balls and spun for 24 hours. The slurry was then dispensed to a slot die coater apparatus fitted with a non-woven (NW) carbon substrate (17 g/m², thickness of 0.2 mm) 300 mm web width operating at 2 m/min. The slurry temperature was maintained between 20 to 25° C. during the coating process as the slurry impregnated the NW carbon substrate. The slurry pump speed was adjusted to limit overcoat and slurry removal by the doctor blades downstream of the slot die slurry injection and prior to drying of the sheet. Partial drying of the coated sheet was accomplished between the coating station and the collection roller with travel time between the two of 3 minutes through forced air convection ovens sections set to 60° C. The collected sheet was further dried in an oven for one hour at 100° C. and stored at room temperature awaiting further processing. The resulting sheet had a thickness of 0.275±0.015 mm and average density of 0.59 g/ml and an adsorption capacity of 38±2 cc/g of CO₂ at 50° C. with 10% CO₂ in a balance Nitrogen feed.

### Example 2

Scanning Electron Microscope (SEM) pictures of sheet from Polyethylimine supported on porous Silica from Example 1b and impregnated on a NW carbon film substrate are shown in FIGS. 3a, 3b, and 3c. Sorbent sheet surface views are shown in FIGS. 3a and 3b, while the cross-sectional view is shown in FIG. 3c.

In FIG. 3a, large scale features such as cracks in the sorbent film at the surface of the sheet and sorbent coated carbon fiber protruding from the surface of the film can be observed. FIG. 3b shows a magnified section of the sorbent sheet surface film showing the porous structure of the denser areas. FIG. 3c shows a cross section of the sorbent sheet with a distribution of interconnected small and large pores facilitating fast transport of fluid components within the sorbent sheet.

### Example 3

A coupon of sorbent sheet from Example 2, was placed into a thermogravimetric apparatus (TGA), dried and conditioned by removing any CO₂ adsorbed from exposure to air and moisture by contacting the sample with Nitrogen while maintaining the sample at 100° C. for 1 hour. The coupon was then cooled to 50° C. in Nitrogen and the stream was switched to a 10% CO₂ in balance Nitrogen stream. The increase in weight of the coupon was recorded and converted into a sorption capacity per g of sample once an equilibration plateau was obtained. The measured capacity for the sheet at 50° C. for CO₂ under an atmosphere of 10% CO₂ in Nitrogen was 38±2 cc/g. For reference the CO₂ adsorption capacity of the sorbent powder by itself under the same test conditions was 45±2 cc/g.

### Example 4: (0=“FAIL”; 1=“PASS”) Water Stability Test

| PEI/EPOXY | C4 | C6 | C8 | C10 | C12 | C14 | C16 | C18 |
|---|---|---|---|---|---|---|---|---|
| 600 | 0 | 0 | 0 | 0 | 0 | 0 | 0 | 0 |
| 1200 | 0 | 0 | 0 | 0 | 0 | 0 | 0 | 0 |
| 2000 | 0 | 0 | 0 | 0 | 0 | 0 | 0 | |
| 10K | 0 | | | | 1 | 1 | 1 | 1 |
| 25K | | | | | 1 | 1 | 1 | 1 |

Pass/fail for Cold water stability test: 0.2 g of powder in 10 g of 20° C. DI water, mixing for 1 h. The liquid was filtered out and the powder dried prior to testing. Testing of CO₂ sorption capacity was conducted for a set of samples prepared with same molar ratio of Nitrogen in PEI/Epoxy-alkane and the same Silica to Amine polymer weight ratio as Example 1 “0” denotes a loss of CO₂ capacity of greater than 5%. “1” denote no loss detected (within measurement error of 1 cc/g CO₂ capacity or 2%). Each row corresponds to a different polymer molecular mass and each column corresponds to the number of carbons in the Alkyl chain in the Epoxy-alkane used for functionalization of the PEI. Water exposure stability table.

### Example 5

Sorbent sheets from Example 2 were placed on a flat screen printer to deposit an area of epoxy resin dots 1.6 mm in diameter with 0.3±0.015 mm in height which were then cured thermally [cross linking of epoxy resin] at 100° C. for 1 h in air. 1.2 m long, 1 inch width strips are cut and stacked to form a structured sorbent bed encased in 1.6 mm thick polymeric (ULTEM) panels for loading into a test apparatus for delivery of a synthetic feed of CO₂ flue gas, steam and Nitrogen and cyclical recovery of a depleted CO₂ synthetic flue gas, a purified CO₂ stream and a moist Nitrogen stream.

The pressure of the Synthetic feed stream [10% CO₂, 3% H₂O in balance N₂] was between 105 kPa and 115 kPa absolute and the temperature was 40±2° C., the steam stream pressure was between 90 kPa and 100 kPa with a temperature of 110±5° C. (superheated), the Nitrogen stream pressure was between 105 kPa and 115 kPa which was split into two streams at a temperature of 110±5° C. and at a temperature of 80±5° C.

The bed sample was placed in a temperature-controlled jacket set at 80° C. to minimize the effect of heat losses through the sides of the bed and to better represent the performance of the larger bed operating with negligeable parasitic heat losses through the side of the bed.

Rapid cycling between these four feed streams resulted in a purification of CO₂. The duration of each addition and flow rates were adjusted until satisfactory CO₂ capture efficiency and CO₂ product purity was achieved. Typically cycle length was between 40 seconds and 90 seconds.

| | Test 1 | Test 2 |
|---|---|---|
| Cycle time (seconds) | 68 | 50 |
| Productivity by volume | 10.2 | 14.1 |
| (TPD/m³) | | |
| Productivity by weight | 46.2 | 64 |
| (TPD/T) | | |
| CO₂ recovery | 84% | 81% |
| CO₂ purity | 86.50% | 85.50% |

Productivity is defined as the number of tonnes of CO₂ purified per day per cubic meter of structured bed volume (TPD/m³) or per tonne of structured bed (TPD/T). CO₂ recovery is defined as the fraction of CO₂ in the product stream versus the quantity of CO₂ introduced into the sorbent bed with the feed. CO₂ purity denotes the product stream after water removal.

### Example 6a

Polymerization taking place in sequence can be seen in Scheme 1 below.

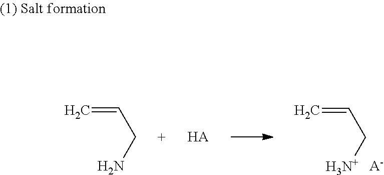

A 250 ml round bottom three-neck glass flask equipped with a condenser, nitrogen inlet and outlet and a Teflon-coated stir bar was utilized for this reaction. The flask was flushed with nitrogen and immersed into an ice bath. It was then loaded with 40 g of isopropanol and 18 g of hydrochloric acid (36-37% concentration). When the mixture had subsequently cooled to a temperature lower than 10° C., 10 g of allylamine at 98% purity was added drop wise while stirring, during which time the temperature was maintained below 20° C. Then, 0.5 g DVB and 1.3 g V-50 was added and the temperature was raised to 55° C. Additional 1.5 g DVB aliquots were then added in 3 separate batches into the flask at 1 h, 2 h, and 3 h. Then, the reaction temperature was raised to 65° C. and maintained at that temperature for 3 more hours. The product was then diluted with 20 g methanol and filtered with a Buchner funnel. The solid portion of the mixture was then suspended in 40 g DI water and 8 g NaOH was added under stirring. Thirty minutes later, the solid was filtered and twice washed with DI water. Then it was further washed with methanol. The powder was then dried in a vacuum oven at 60° C. overnight. The post-treatment on solid powder is the same as in Example 1. A 20% yield was obtained and a CO₂ capacity of 36.8 cc/g resin was measured at 50° C. with 10% CO₂ and 90% He flow gas. Then, 4 g DVB-80 (DVB Aldritch) co-monomer and 0.85 g 2,2′-azobis(2-amidinopropane) dihydrochloride (V-50) initiator was added and the temperature was raised to 55° C. and maintained at that temperature for 18 h with stirring. The product was then diluted with 20 g methanol and filtered with a Buchner funnel. The solid portion was then suspended in 40 g DI water and 8 g NaOH was added with stirring. Thirty minutes later, the solid was filtered and twice washed with DI water. It was further washed with methanol. The resulting powder was then dried in a vacuum oven at 60° C. overnight.

| | Example 6a |
|---|---|
| CO₂ Cap @50° C. with 10% CO₂ in | 36.8 |
| He | |

Surface area and pore volume

| | |
|---|---|
| BET surface area (m2/g) | 71 |
| Pore volume 17-3000 Å (cm3/g) | 0.27 |
| Average pore size (Å) | 150.5 |

### Example 6b

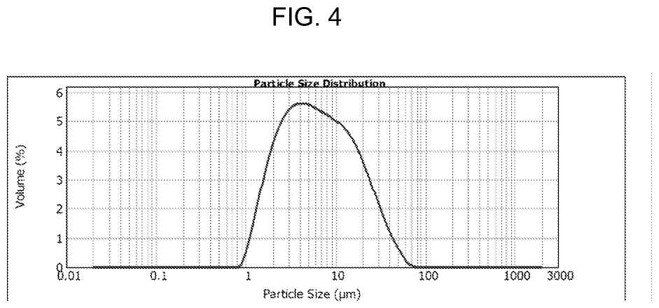

The reaction was carried out in a 500 ml round bottom three-neck glass flask equipped with mechanical stirring of a Teflon-coated shaft and blades, a nitrogen inlet and outlet and a thermal meter. The flask was immersed into an ice bath and flushed with nitrogen, followed by loading with 165 g HCl (36-37%) and 1.65 g NaCl. Then the mixture was cooled to a temperature around 15° C., 110 g of allylamine was added slowly with stirring, during which time the temperature was maintained below 30° C. After cooling to 15-20° C., 17.5 g of citric acid was added slowly and the resultant pH was measured at 5.5. Then, 18 g V-50 and 6 g DVB were added and the temperature was raised to 65° C. 44 g of DVB was added by syringe pump over a period of 4.3 h during which time the temperature was maintained between 67 to 70° C. After DVB addition, the reaction was continued for 2.5 more hours with a temperature increased to 82° C. The post-treatment on solid powder was the same as in Example 14 below. A 46.3% yield was obtained and a CO₂ capacity at 50° C. with 10% CO₂ and 90% He flow gas of 46.9 cc/g resin was measured. The particle size and distribution is shown in FIG. 4. It is a broad single-modal distribution curve with a peak at around 4 μm and a tail to 70 μm. Scanning Electron Microscope pictures (SEM) demonstrate that the solid polymer is primarily comprised of aggregates of nano particles.

### Example 6c

Three repeat polymerization reactions were carried out at larger scale in a 5 L round bottom three neck glass flask equipped with mechanical stirring of Teflon coated shaft and blade. The flask was flushed with nitrogen and charged with 1004 g of cold (about 8-10° C.) dilute HCl aqueous solution containing 68 g of allylamine, 6.6 g of NaCl, and 96 g of citric acid. The reaction solution had a pH of around 6. Then, 72 g V-50 and 24 g of DVB was added and the temperature was raised to 65° C. 176 g of DVB g was then added by syringe pump over a period of 4.25 h during which time the temperature was maintained between 67 to 70° C. and 640 g water was added for dilution when the viscosity increased. After DVB addition, the reaction was continued for 1.5 more hours with the temperature raised to 80° C.

| | | CO2 Cap | d(0.5) aft sonic |
|---|---|---|---|
| Example # | Batch | @50° C. (cc/g) | (μm) |
| 6c-1 | #180619 | 37.8 | 2.509 |
| 6c-2 | #180626 | 38 | 3.414 |
| 6c-3 | #180703 | 39.6 | 3.162 |

CO₂ adsorption capacity at 10% CO₂ in He at 50° C. for the repeat scale up samples.

| Example # | Batch | C (wt %) | H (wt %) | N (wt %) | S (wt %) |
|---|---|---|---|---|---|
| 6c-z | #180619 | 72.99 | 11.73 | 7.37 | 0.82 |
| 6c-2 | #180626 | 73.01 | 13.49 | 7.09 | 1.08 |
| 6c-3 | #180703 | 68.80 | 12.49 | 8.02 | 0.61 |

Composition of the dry polymer from elemental analysis.

### Example 7

Repeated exposure cycles to air for 1 h at 120° C. have been carried out on a presentative sample of the allylamine co-DVB polymer presented herein as well as a reference commercially available amine doped resin containing Phenyl amine [Lewatit1065]. Between each cycle the CO₂ capacity of the material was measured at 50° C.

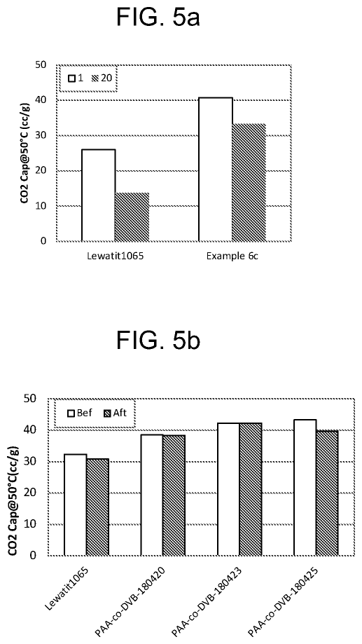

FIG. 5a compares the CO₂ capacity of the samples after 1 and after 20 air exposure cycles. The CO₂ capacity at 50° C. per gram of sorbent under 10% CO₂ in N₂ is shown on the y-axis, while an amine doped resin containing Phenyl amine [Lewatit1065] sorbent and an allylamine co-DVB polymer sorbent are shown along the x-axis. The unshaded bar shows the CO₂ capacity after 1 cycle while the shaded bar shows the CO₂ capacity after 20 cycles. The CO₂ volume adsorbed is reported at STP (Standard Temperature and Pressure).

FIG. 5b presents the before and after water soaking CO₂ sorption capacity for a reference amine containing resin [Lewatit1065] and the porous polymers disclosed herein. The CO₂ capacity at 50° C. per gram of sorbent under 10% CO₂ in N₂ is shown on the y-axis, while an amine doped resin containing Phenyl amine [Lewatit1065] sorbent and allylamine co-DVB polymer sorbents 180420, 180423, and 180425, are shown along the x-axis. The unshaded bar shows the CO₂ capacity before soaking, while the shaded bar shows the CO₂ capacity after soaking. The CO₂ volume adsorbed is reported at STP.

Two of the samples of porous amine sorbents prepared have shown no CO₂ capacity loss and superior sorption capacity compared to the reference indicating effective incorporation of the amine monomer in the porous copolymer with little unreacted monomer left in the solid sorbent.

The sample from example 6a is significantly more oxidation stable than the reference amine resin material. Hot water stability was tested by a comparison of CO₂ capacity of the resin before and after soaking of the powder for one hour under mixing.

### Example 8

### Preparation of Sorbent Sheet:

164 g of sample from Example 6c prior to drying (containing 81% dry polymer) was mixed with 300 g of water and 54 g (43% wt suspension) of Polyvinyl Alcohol polymer (Molecular weight about 200 k Dalton) in a high shear mixer for 1 h and then transferred to a ball milling vessel with Zirconia stabilized beads and spun for 24 hours. The slurry was then dispensed into a slot die coater apparatus fitted with NW carbon substrate (17 g/m², thickness 0.2 mm) 300 mm web width operating at 2 m/min. The slurry temperature was maintained between 2° and 25° C. during the coating process as the slurry impregnated the NW carbon substrate. The slurry pump speed was adjusted to limit overcoat and slurry removal by the doctor blades downstream of the slot die slurry injection and prior to drying of the sheet. Partial drying of the coated sheet occurred between the coating station and the collection roller because the sheet travelled for 3 minutes through forced air convection ovens sections set to 60° C. The collected sheet was dried further in an oven for 1 hour at 100° C. and stored at room temperature until further processing. The resulting sheet had a thickness of 0.18±0.01 mm and average density of 0.47 g/ml and an adsorption capacity of 30±2 cc/g of CO₂ at 50° C. with a 10% CO₂ in a balance Nitrogen feed.

### Example 9

FIG. 6a presents Example 6b powder Scanning Electron Microscope (SEM) image and FIG. 6b presents Example 8 sorbent sheet cross-section SEM images. Submicron diameter polymer particles are observed in FIG. 6a while a porous network with pores in the micron size range can be observed (dark areas) in FIG. 6b. Interstitial space between polymer particles is preserved upon coating.

FIG. 6b is a powder SEM image of a cross section of sorbent sheet from example 8 showing the polymer particles and porosity of the sorbent film. Darker areas are voids remaining between sorbent particles after formation of the sorbent sheet. Those voids or pores are interconnected in a tridimensional network and enable fast diffusion and transport of the fluid or gas component up to the surface of individual sorbent particles.

### Example 10

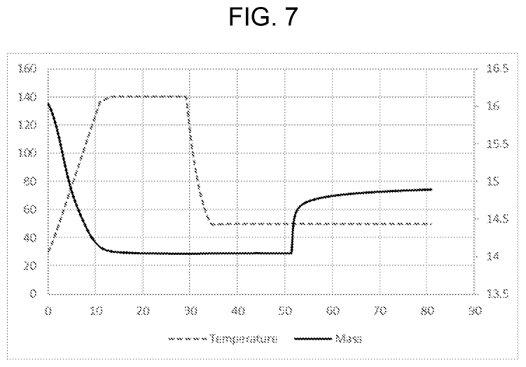

A coupon of sorbent sheet from example 9, was placed into a thermogravimetric apparatus (TGA) dried and conditioned by removing any CO₂ adsorbed from exposure to air and moisture by contacting the sample with Nitrogen while maintaining the sample at 140° C. for 20 minutes. The coupon was then cooled to 50° C. in Nitrogen and the stream was switched to a 10% CO₂ in balance Nitrogen stream. The increase in weight of the coupon was then recorded and converted in a sorption capacity per g of sample once an equilibration plateau was obtained. The measured capacity for the sheet at 50° C. for CO₂ under an atmosphere of 10% CO₂ in balance Nitrogen was 30±2 cc/g. For reference the CO₂ adsorption capacity of the sorbent powder by itself under the same test condition was 35±2 cc/g. FIG. 7 shows the mass change of the sorbent sheet coupon during the TGA test with the sample weight on the right axis versus time as well as the temperature near the coupon on the left axis. The sample is first exposed to Nitrogen at 140° C. for 20 minutes in order to dry the material and remove CO₂ adsorbed from exposure to air.

The gas composition in the TGA furnace was switched to 10% CO₂ in N₂ at the 51 minute mark. In less than 2 minutes 80% of the weight gain of the sample sheet is observed indicating a rapid adsorption of CO₂ in the sorbent sheet. The 6% mass change of the sample 20 minutes after introduction of CO₂ correspond to a sorption capacity of about 30 cc/g STP.

### Example 11

The sorbent sheets from example 10 were placed on a flat screen printer to deposit an area of epoxy resin dots 1.6 mm diameter of 0.25±0.01 mm height which were then thermally cured [cross linking of epoxy resin] at 100° C. for 1 h in air. 1.2 m long, 1 inch width strips were cut and stacked to form a structure sorbent bed encased in 1.6 mm thick ULTEM panels for loading into a test apparatus for delivery of a synthetic feed of CO₂ flue gas, steam and Nitrogen and cyclical recovery of depleted CO₂ synthetic flue gas, a purified CO₂ stream and a moist Nitrogen stream.

The pressure of the Synthetic feed stream [10% CO₂, 3% H₂O in balance Nitrogen] was between 105 kPa and 115 kPa absolute and a temperature of 40±2° C., the steam stream pressure was between 90 kPa and 100 kPa with a temperature of 110±5° C. (superheated), the Nitrogen stream pressure was between 105 kPa and 115 kPa split into two streams at temperatures of 110° C.±5° C. and of 80° C.±5° C.

The bed sample was placed in a temperature-controlled jacket set at 80° C. to minimize the effect of heat losses through the sides of the bed and better represent the performance of larger bed operating with negligible parasitic heat losses through the side of the bed.

Rapid cyclic between these four feed streams resulted in a purification of CO₂. The duration of each addition and flow rates were adjusted until satisfactory CO₂ capture efficiency and CO₂ product purity was achieved. Typical cycle length was between 40 seconds and 120 seconds.

| | Test 1 | Test 2 |
|---|---|---|
| Cycle time(s) | 123 | 109 |
| Productivity by volume | | |
| (TPD/m³) | 3 | 3.3 |
| Productivity by weight | | |
| (TPD/T) | 22.6 | 24.8 |
| CO₂ recovery | 60% | 40% |
| CO₂ purity | 80% | 78% |

Productivity is defined as the number of tonnes of CO₂ purified per day per cubic meter of structured bed volume or per tonne of structured bed. CO₂ recovery is defined as the fraction of CO₂ in the product stream versus the quantity of CO₂ introduced into the sorbent bed with the feed. CO₂ purity denotes the product stream after water removal.

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the scope thereof (including combinations of various described embodiments or portions thereof). Accordingly, the scope of the invention is to be construed in accordance with the substance defined by the claims.

1. A solid sorbent comprising:
a polymeric amine having an average molecular weight greater than 2000 Dalton,
wherein said solid sorbent is insoluble in water, and forms a porous network, and
wherein said solid sorbent is in the form of particles or a film or a sheet.

2. The solid sorbent of claim 1, wherein said polymeric amine comprises a first soluble domain, and a second insoluble domain.

3. The solid sorbent of claim 1, wherein said polymeric amine comprises a primary amine and a secondary amine, wherein a mass fraction of said primary amine and said secondary amine combined is greater than 6% mass fraction of nitrogen relative to the mass of said polymeric amine.

4. (canceled)

5. The solid sorbent of claim 1, wherein the solid sorbent has an average pore volume greater than 0.2 ml/g.

6. (canceled)

7. The solid sorbent of claim 1, wherein said solid sorbent has an average BET surface area within a range of 4 m²/g to 500 m²/g.

8. (canceled)

9. (canceled)

10. (canceled)

11. The solid sorbent of claim 1, wherein said polymeric amine comprises a co-polymer formed from the reaction of a vinyl amine and a divinyl monomer and further comprises an interconnected porous structure.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. The solid sorbent of claim 1, wherein said solid sorbent has a CO₂ equilibrium capacity to heat capacity ratio of between 15 to 40 cc stp CO₂/(J/K), per unit heat capacity of said solid sorbent, wherein said equilibrium capacity is measured under 15% CO₂ feed mixture at 50° C.

26. A solid sorbent comprising:
a polymeric amine formed into a porous solid characterized by:
(a) a CO₂ equilibrium capacity, wherein said solid sorbent has a CO₂ equilibrium capacity to heat capacity ratio of between 15 to 40 cc stp CO₂/(J/K) per unit heat capacity of said solid sorbent, wherein said equilibrium capacity is measured at 50° C. under 15% CO₂ feed mixture;
(b) a kinetic adsorption rate, wherein said kinetic adsorption rate is greater than 0.03 mmol/g/s when in contact with a CO₂ mixture, wherein said CO₂ mixture comprise 15% CO₂ and a temperature between 30° C. and 50° C.;
(c) a heat of adsorption for CO₂, wherein said heat of adsorption for CO₂ is between 70 and 120 kj/mol of CO₂ adsorbed.

27. The solid sorbent of claim 26, wherein the solid sorbent is further characterized by a reduction in adsorption capacity of less than 10% of adsorption capacity after 50,000 cycles of operation, wherein during said operation said solid sorbent is exposed to a regenerating step, wherein said regenerating step is at a temperature within a range of between 90° C. to 130° C. and at a relative humidity within a range of 50% to 100%.

28. (canceled)

29. (canceled)

30. (canceled)

31. The solid sorbent of claim 26, wherein said polymeric amine further comprises a grafted alkylamine supported on a porous support, said porous support having a pore volume in a range between 0.7 to 1.5 ml/g, and a grafted function on amine groups comprises hydrophobic groups.

32. (canceled)

33. (canceled)

34. A sorptive gas contactor comprising:
a plurality of sorbent sheets, each comprising said solid sorbent according to claim 1, said sorbent sheets having a thickness in a thickness range of 0.1 mm to 3 mm, or preferably in a range of 0.2 mm to 1 mm, and positioned to form passages between said plurality of sorbent sheets to enable flow of a gas stream between and in contact with said sorbent sheets.

35. A sorptive gas contactor comprising:
a plurality of sorbent sheets, each of the plurality of sorbent sheets comprising a solid sorbent, each of said sorbent sheets having a thickness in a thickness range of 0.1 mm to 3 mm, and positioned to form passages between said plurality of sorbent sheets to enable flow of a gas stream between and in contact with said sorbent sheets, and
wherein said solid sorbent sheets have a density in a range of 0.2 g/cm³ to 0.8 g/cm³, and comprise a polymeric amine polymer with greater than 5 weight % of nitrogen from a primary or a secondary amine functional group, said polymeric amine formed as a co-polymer from a vinyl amine monomer having a molecular weight less than 100 Dalton and a divinyl monomer having a molecular weight greater than 100 Dalton, or formed from a reaction of a water-soluble polymeric amine with long chain alkyl (8 carbon or greater) groups.

36. (canceled)

37. The sorptive gas contactor of claim 35, wherein said sorbent sheets are embossed, and/or have a protuberance for creating said passage between said plurality of stacked sorbent sheets.

38. The sorptive gas contactor of claim 35, wherein at least some of said plurality of stacked sorbent sheets have a non-planar cross-section for creating said passages between said plurality of stacked sorbent sheets, wherein said non-planar cross-section is an undulate, a sine wave, a square wave, a triangle wave, or a saw tooth wave cross-section.

39. The sorptive gas contactor of claim 35, having a passage void fraction between said plurality of said sorbent sheets, wherein said passage void fraction is in a range of 20% to 80%, or preferably 30% to 75%.

40. (canceled)

41. A sorptive gas separation process for separating a first component from a multi-component fluid stream comprising at least a first component and a second component, said process comprising:
(a) providing a sorptive gas contactor comprising a solid sorbent of any one of claim 1;
(b) flowing said multi-component fluid stream through said sorptive gas contactor, sorbing at least a portion of said first component from said multi-component fluid stream on said solid sorbent, forming a first product stream, and recovering said first product stream from said sorptive gas contactor, wherein said first product stream depleted in said first component relative to said multi-component fluid stream; and
(c) desorbing at least a portion of said first component sorbed on said solid sorbent, forming a second product stream, and recovering said second product stream from said sorptive gas contactor, wherein said second product stream is enriched in said first component relative to said multi-component fluid stream.

42. (canceled)

43. The process of claim 41, further comprising in step (b) exposing said solid sorbent to a first relative humidity, wherein said first relative humidity is at least 20% relative humidity as measured at the inlet of said sorptive gas contactor.

44. (canceled)

45. (canceled)

46. (canceled)

47. The process of claim 41, further comprising in step (c) controlling said regeneration stream to have a partial pressure of steam equal to or greater than 0.3 Bar absolute prior to admitting said regeneration stream into said sorptive gas contactor.

48. The process of claim 41, after step (c) further comprising a step (d), wherein step (d) comprises: exposing said solid sorbent to a third relative humidity, wherein said third relative humidity is less than said second relative humidity, and forming a third product stream, and recovering said third product stream from said sorptive gas contactor.

49. (canceled)

50. The process of claim 41, wherein flowing said multi-component fluid stream through said sorptive gas contactor in step (b) comprises contacting said solid sorbent with said multi-component fluid stream at a pressure between about 1 bar absolute and about 2 bar absolute.

51. (canceled)

52. (canceled)

53. (canceled)

54. (canceled)
